(19) United States
(12) Patent Application Publication
(10) Pub. No.: US 2026/0211120 A1
(43) Pub. Date: Jul. 23, 2026

(54) MOTOR VEHICLE DETECTION SYSTEM COMPRISING A MODULE FOR EMITTING, AND A MODULE FOR RECEIVING, A LIGHT BEAM

(71) Applicant: VALEO VISION, Bobigny (FR)

(72) Inventors: Mickael MIMOUN, Bobigny (FR); Sidahmed BEDDAR, Bobigny (FR); Pierre RENAUD, Bobigny (FR); Hafid EL-IDRISSI, Bobigny (FR); Jose AFONSO, Bobigny (FR); Matheo GOURDON, Bobigny (FR); Geoffrey PIQUARD, Bobigny (FR)

(73) Assignee: VALEO VISION, Bobigny (FR)

(21) Appl. No.: 19/142,404

(22) PCT Filed: Dec. 19, 2023
(86) PCT No.: PCT/EP2023/086644

§ 371 Date: Jun. 23, 2025

(30) Foreign Application Priority Data
Dec. 23, 2022 (FR) FR2214442

(51) Int. Cl. G01S 17/931; G01S 7/484; G01S 7/4861; G01S 7/4865; G01S 17/06; G01S 17/50

(52) U.S. Cl. CPC G01S 17/931; G01S 7/484; G01S 7/4861; G01S 7/4865; G01S 17/06; G01S 17/50

(57) ABSTRACT

The invention relates to a light system. The light system includes an emitting module that includes a light module capable of emitting a light beam that produces a flashing photometric function and a modulation unit arranged to modulate the emitted light beam on the basis of a modulating data sequence, a receiving module capable of receiving a light beam, and a computing unit arranged to generate modulating data sequences having different duty cycles in order to emit different modulated light beams during each active and inactive phase. The computing unit being arranged to determine a time of flight separating the emission of the first or of the second emitted modulated light beam from the reception of a light beam received by the receiving module.

### TECHNICAL FIELD

The invention relates to the field of automotive lighting and to functions for the detection of an object by an automotive vehicle and estimation of the distance between this object and the vehicle. More precisely, the invention relates to a lighting system for an automotive vehicle that is capable of carrying out telemetry functions by means of the light it emits.

### BACKGROUND OF THE INVENTION

In the automotive field, it is known to use a pulsed light beam emitted by a luminous module of a luminous system for an automotive vehicle to perform a given photometric function.

Conventionally, the light source used to emit this light beam is controlled by a pulse-width-modulated (PWM) electrical signal. The light source is thus periodically activated and deactivated by this PWM signal, so that the emitted light beam is composed of successive light pulses with a frequency that is high enough that the human eye can no longer distinguish them. The intensity of the emitted light beam depends on the duty cycle of this PWM signal, so that it is possible to control said intensity by adjusting this duty cycle and therefore to perform a photometric function.

Beyond performing one or more photometric functions, such as a daytime running light or low-beam lighting, various functions can be carried out by this type of luminous module. For example, the light source of the luminous module can be controlled so that the pulses of the emitted light beam carry a data sequence. The luminous system can thus be equipped with a receiving module in order to receive the emitted light beam after reflection by an object near the vehicle. A computing unit of the automotive vehicle can then, after detection of the data sequence in the received light beam, determine the time of flight of the emitted light beam and thus evaluate the distance between the vehicle and the object.

In this way, the light beam can retain its original function, namely performing a photometric function, while allowing the luminous system to carry out a telemetry function, which can be particularly advantageous for example for driving assistance functions or in the context of autonomous or semi-autonomous driving.

However, this type of system has a drawback for some photometric functions, in particular for flashing functions. For example, a direction-indicator function carried out by a luminous module has to be composed of a sequence of successive cycles each composed of an “active” phase, in which the luminous module is turned on, and of an “inactive” phase, in which the luminous module is turned off. Therefore, its use for a telemetry function is limited to the active phases, since no light beam capable of supporting this telemetry function is emitted during the inactive phases. This intermittent absence can thus lead to a loss of tracking of an object detected during an active phase, in particular when the relative speed between this object and the vehicle is high.

### SUMMARY OF THE INVENTION

There is thus a need for a luminous system for an automotive vehicle that is capable of performing both a given flashing photometric function and a telemetry function, the telemetry function remaining available during the inactive phases of the photometric function.

The present invention falls within this context, and aims to meet this need.

To this end, a subject of the invention is a luminous system for an automotive vehicle, comprising:
a. an emitting module comprising a luminous module capable of emitting a light beam whose spectrum has at least a portion in the visible spectrum, and a modulation unit designed to control the luminous module for the performance, on the basis of said emitted light beam, of a flashing photometric function comprising a sequence of successive cycles each composed of an active phase followed by an inactive phase, the modulation unit being capable of receiving what is referred to as a modulating data sequence and being designed to modulate said emitted light beam on the basis of the sequence of received data;
b. a receiving module capable of receiving a light beam, wherein the receiving module comprises an elementary acquisition module comprising a photodetector capable of converting a light signal it receives into an electrical signal.

According to the invention, the luminous system is characterized in that it comprises a computing unit designed to generate a first modulating data sequence having a first duty cycle and to transmit said first modulating data sequence to the modulation unit in order for a first modulated light beam to be emitted by the luminous module during each active phase; in that the computing unit is designed to generate a second modulating data sequence having a second duty cycle lower than the first duty cycle and to transmit said second modulating data sequence to the modulation unit in order for a second modulated light beam to be emitted by the luminous module during each inactive phase; and in that the computing unit is designed to determine a time of flight between emission of the first or second emitted modulated light beam and reception of a light beam received by the receiving module on the basis of an electrical signal converted by the photodetector on the basis of said received light beam.

It will thus be understood that the invention proposes modulating a first light beam, emitted by a luminous module of the emitting module only during each active phase, which natively performs a flashing photometric function, such as a direction indicator. The resulting light beam may, for example, be a pulsed beam, each pulse corresponding to one or more consecutive high values of the first modulating sequence and the interval between two consecutive pulses corresponding to one or more consecutive low values of the first modulating sequence. Each pulse of the modulated light beam is emitted with a peak luminous power, so that the average luminous power of the first emitted modulated light beam, which is necessary to perform the photometric function, is thus defined by the peak luminous power and the duty cycle of the modulating data sequence. Since the modulating sequence is generated cyclically, the first emitted modulated light beam will periodically contain this sequence while continuously performing the photometric function during each active phase. The computing unit can thus detect, on the basis of the electrical signal converted by the photodetector, the presence of this modulating sequence in a beam received by the receiving module and can thus detect the presence of an object in the environment of the vehicle and estimate its distance from the vehicle.

The invention also proposes modulating another light beam, emitted by the luminous module of the emitting module only during each inactive phase. However, this second beam will be modulated with a data sequence whose duty cycle is low, so that the average power of the second modulated beam is particularly low, in particular with respect to the average power of the first modulated beam. It will thus be understood that the second modulated beam is imperceptible and that it allows the luminous module to remain substantially turned off, so as to meet the regulatory requirements of the flashing photometric function, while allowing the computing unit to detect, on the basis of this second modulated beam, the presence of an object during each inactive phase. It will be noted that it will be possible to employ an identical telemetry method for the first and second light beams, or conversely to use different methods, and in particular a method of direct estimation of a time of flight of the second light beam, depending on the duty cycles employed.

In one embodiment of the invention, the luminous module is capable of emitting a first, respectively a second, light beam whose spectrum has a wavelength in the visible, notably between 400 nm and 500 nm. For example, the first, respectively the second, light beam may have what is referred to as an amber or orange color. Advantageously, the luminous module comprises a light source comprising a semiconductor generator capable of emitting an elementary light beam, notably whose spectrum has a wavelength in the visible, and a photoluminescent element capable of converting said elementary light beam in order to obtain said light beam.

The semiconductor may, for example, be a gallium nitride (GaN) capable of emitting, by electroluminescence and in response to an electric current passing through it, blue light rays. The photoluminescent element may, for example, be in the form of a resin comprising cerium-doped yttrium aluminum garnet (CE: YAG) capable of absorbing blue light and, by photoluminescence and in response to excitation by this light, of emitting yellow light rays. The photoluminescent element is disposed on the generator in such a way that one portion of the blue light rays excites this element so that it emits, by photoluminescence, orange light rays. The other portion of the blue light rays passes through this element. Thus, when supplied with electric power, the light source simultaneously emits blue and yellow light rays, in such proportions that the light thus formed appears yellow, orange or amber to the human eye.

The light source may thus be a laser source, a light-emitting diode, a vertical-cavity surface-emitting laser (VCSEL) diode or a superluminescent diode (SLED).

In one embodiment of the invention, the luminous module comprises a light source, the modulation unit being designed to control said light source in order for the first modulated light beam to be emitted by the luminous module during each active phase and to control said light source in order for the second modulated light beam to be emitted by the luminous module during each inactive phase. It will thus be understood that the same light source is used to emit the first modulated light beam during the active phase and to emit the second modulated light beam during the inactive phase.

Advantageously, the luminous module may comprise an optical unit arranged to project the light rays emitted by the light source so as to form said first or second light beam.

In another embodiment, the luminous module comprises a first light source and a second light source, the modulation unit being designed to control said first light source in order for the first modulated light beam to be emitted by the luminous module during each active phase and to control said second light source in order for the second modulated light beam to be emitted by the luminous module during each inactive phase.

Advantageously, the luminous module comprises a common optical unit arranged to project the light rays emitted by the first and second light sources so as to form said first and second light beams. As a variant, the module may comprise two separate optical units each arranged to project the light rays emitted by one or the other of the light sources so as to form said first and second light beams. Where appropriate, the second light source and the optical unit may be arranged to together perform another regulatory photometric function, capable of being activated when the flashing photometric function is deactivated.

Advantageously, the computing unit is designed to generate a first data sequence having a first duty cycle greater than 10% and to generate a second data sequence having a second duty cycle less than 5%. Preferably, the computing unit may generate a first sequence whose duty cycle is greater than or equal to 50% and may generate a second sequence whose duty cycle is less than or equal to 1%. This ensures that the average luminous power of the second modulated light beam is a particularly small fraction of the average luminous power of the second light beam.

In one embodiment of the invention, the computing unit is designed to generate a second data sequence having a duty cycle determined so that the second modulated light beam comprises a single light pulse. Where appropriate, the computing unit being capable of receiving an electrical signal converted by the photodetector on the basis of a light beam received by the receiving module, the computing unit is designed to detect a light pulse in the received light beam on the basis of said electrical signal and to determine a time of flight between emission of said light pulse of the second light beam and reception of said detected light pulse by the receiving module. In this mode, the computing unit thus performs a direct estimation of the time of flight of the second light beam by detecting, for example by thresholding a portion of the electrical signal corresponding to the duration of the second data sequence, the presence of an echo of the light pulse of the second light beam.

Preferably, the second data sequence is periodically transmitted to the modulation unit so that the second modulated light beam emitted during an inactive phase comprises a train of light pulses separated by a constant time interval. This time interval thus allows an unambiguous detection distance to be defined. Still preferably, the computing unit is designed to determine the times of flight between emissions of a train of light pulses of the second light beam and reception of a train of detected light pulses by the receiving module. Where appropriate, the computing unit is designed to generate a histogram of the times of flight determined during a given period of time, to detect the presence of one or more objects in the environment of the vehicle on the basis of the histogram, in particular by selecting one or more of the determined times of flight whose occurrences are higher than a given threshold, and possibly to estimate a distance between said object(s) and the vehicle on the basis of the selected times of flight.

In another embodiment, the luminous system may comprise a demodulation unit connected to the photodetector and designed to extract what is referred to as a demodulated data sequence from an electrical signal converted by this photodetector; and, the computing unit being capable of receiving a data sequence demodulated by the demodulation unit from an electrical signal converted by the photodetector on the basis of a light beam received by the receiving module, the computing unit is designed to estimate values of a correlation function between said demodulated data sequence and said second modulating data sequence and to determine a time of flight between emission of said second emitted modulated light beam and reception of said received light beam on the basis of the values of the correlation function. In other words, in this embodiment, the computing unit can estimate the values of a correlation function between the demodulated data sequence and the second modulating data sequence, each value of the correlation function being associated with a value of a time shift of the modulating sequence, or of the demodulated sequence, used to estimate that value of the correlation function.

Advantageously, the luminous system comprises a demodulation unit connected to the photodetector and designed to extract what is referred to as a demodulated data sequence from an electrical signal converted by this photodetector; and, the computing unit being capable of receiving a data sequence demodulated by the demodulation unit from an electrical signal converted by the photodetector on the basis of a light beam received by the receiving module, the computing unit is designed to estimate values of a correlation function between said demodulated data sequence and said first modulating data sequence and to determine a time of flight between emission of said first emitted modulated light beam and reception of said received light beam on the basis of the values of the correlation function.

Preferably, the computing unit is designed to generate said first modulating data sequence, and possibly said second modulating data sequence, on the basis of an initial pseudo random binary sequence.

A pseudo random binary sequence (PRBS) is a sequence of data composed of high values, namely “1s”, and low values, namely “0s”. This type of sequence has particularly advantageous properties. Specifically, its autocorrelation function is maximum for a zero time shift, that is to say when the sequence is compared with itself, and has a value substantially lower than this maximum for all other time shifts, that is to say when the sequence is compared with time-shifted versions of itself. Moreover, the cross correlation function between two pseudo random binary sequences is substantially less than the maximum of the autocorrelation functions of these sequences. Finally, this type of sequence is generally generated by means of a linear feedback shift register (LFSR), which produces a periodic recursive sequence whose pattern is a pseudo random binary sequence.

Given the autocorrelation properties of the pseudo random binary sequences, the correlation function thus estimated will thus be maximum for the time shift value corresponding to the time of flight of the emitted, reflected and then received modulated light beam, even when noise is high. Consequently, the computing unit can identify this time shift value associated with the maximum value of the correlation function with high precision and deduce therefrom the distance between the object from which the beam has been reflected and the automotive vehicle. Furthermore, given the cross correlation properties, it thus appears unlikely that the reception of a modulated light beam emitted by an equivalent system of another automotive vehicle will lead to the detection of a false positive. Finally, it will be understood that the detection is carried out not on a single pulse but on a complete data sequence, so that the signal-to-noise ratio of the system is improved.

Advantageously, the computing unit is designed to generate an initial pseudo random binary sequence of maximum size and to generate said first and/or second modulating data sequence on the basis of said initial sequence. For a pseudo random binary sequence, the maximum of the autocorrelation function, that is to say for a zero time shift, corresponds to the number of high values in the sequence, while its value for all other time shifts corresponds to this number of high values multiplied by the duty cycle of the sequence, that is to say to the ratio of the number of high values to the total length of the sequence. For a pseudo random binary sequence of maximum size, also called an MLS (Maximum Length Sequence) or M sequence, this duty cycle is 50%. This duty cycle value thus makes it possible to increase the accuracy of detection of the peak, or of estimation of the maximum, of the autocorrelation function, and therefore the accuracy of estimation of the distance from the vehicle to the detected object.

In one embodiment of the invention, the computing unit is designed to estimate each value of the correlation function between said demodulated data sequence and said first and/or second modulating data sequence by evaluating the cross correlation of the demodulated data sequence and the first and/or second modulating data sequence delayed by a given duration associated with said value. In other words, each value of the correlation function is thus associated with a value of a time shift of the first and/or second modulating sequence used to estimate that value of the correlation function. The computing unit is thus designed to identify the time shift value associated with the maximum value of the cross correlation function.

In one embodiment of the invention, the computing unit is designed to generate and transmit the first modulating data sequence to the modulation unit in order for a first modulated light beam to be emitted by the luminous module during each active phase, the computing unit being designed to estimate a distance between the vehicle and an object in the environment of the vehicle on the basis of the determination of a time of flight between emission of the first modulated light beam and reception of a light beam received by the receiving module. Where appropriate, the computing unit is designed to estimate a relative movement speed of the object with respect to the vehicle on the basis of said estimated distance, and the computing unit is designed to, when said estimated relative speed is greater than a given threshold speed, generate and transmit said second modulating data sequence to the modulation unit in order for a second modulated light beam to be emitted by the luminous module during each inactive phase. It will thus be understood that the first light beam performs a telemetry function during the active phases, thus making it possible, on the basis of several successively estimated distances, to estimate the movement speed of the object with respect to the vehicle. When this estimated speed, or when a speed predicted on the basis of this estimated speed, exceeds a given threshold, it is therefore possible to lose the tracking of the object which has been detected during an active phase in the course of the subsequent inactive phase. In this case, the computing unit can thus activate the telemetry function performed by the second light beam during the subsequent inactive phase or phases, in order to ensure continuity of detection and tracking of the object.

Advantageously, the receiving module comprises a plurality of elementary acquisition modules arranged in an array.

In one embodiment of the invention, the receiving module comprises a plurality of elementary acquisition modules, each comprising a photodetector capable of converting a light signal it receives into an electrical signal.

For example, the set of photodetectors can form a sensor, for example a single electronic component.

Advantageously, the photodetector of the or each elementary acquisition module is an avalanche photodiode. This type of photodetector is also known as a single-photon avalanche diode (SPAD). The set of avalanche photodiodes can thus form a silicon photomultiplier (SiPM). This type of photodetector can detect the incidence of a single photon with high gain, for example of the order of 106, and thus compensate for degradations of the signal-to-noise ratio due to external conditions.

According to one exemplary embodiment of the invention, the receiving module may comprise an optical unit arranged in front of the elementary acquisition module.

In one embodiment of the invention, the emitting module is arranged in a front headlamp of the automotive vehicle. Advantageously, the receiving module and the emitting module are arranged in a front headlamp of the automotive vehicle.

Preferably, the luminous module is arranged so that the first light beam wholly or partially participates in the performance of a first predetermined regulatory photometric function.

Still preferably, the luminous module is arranged so that the first light beam wholly or partially participates in the performance of a first “direction-indicator” signaling function. Where appropriate, the modulation unit may be designed so that each active phase has a duration of substantially 500 ms and that each inactive phase has a duration of substantially 500 ms.

A further subject of the invention is a method for detecting an obstacle located in the environment of an automotive vehicle and for estimating the distance between this object and the vehicle, the method being carried out by a luminous system, in particular by a luminous system according to the invention.

### BRIEF DESCRIPTION OF DRAWINGS

The present invention will now be described using examples that are only illustrative and by no means limit the scope of the invention, and with reference to the appended drawings, in which drawings the various figures show:

FIG. 1 schematically and partially shows a view of a system for an automotive vehicle according to one exemplary embodiment of the invention;

FIG. 2 schematically and partially shows a telemetry method carried out by the system of FIG. 1;

FIG. 3 schematically and partially shows a view from above of a road scene when the telemetry method is carried out by the system of FIG. 1;

FIG. 4 schematically and partially shows a telemetry method carried out by the system of FIG. 1; and

FIG. 5 schematically and partially shows an example of a control signal for the performance of a flashing photometric function carried out by the system of FIG. 1.

### DETAILED DESCRIPTION OF THE INVENTION

In the following description, elements that are identical in terms of structure or function and that appear in various figures retain the same reference signs, unless otherwise specified.

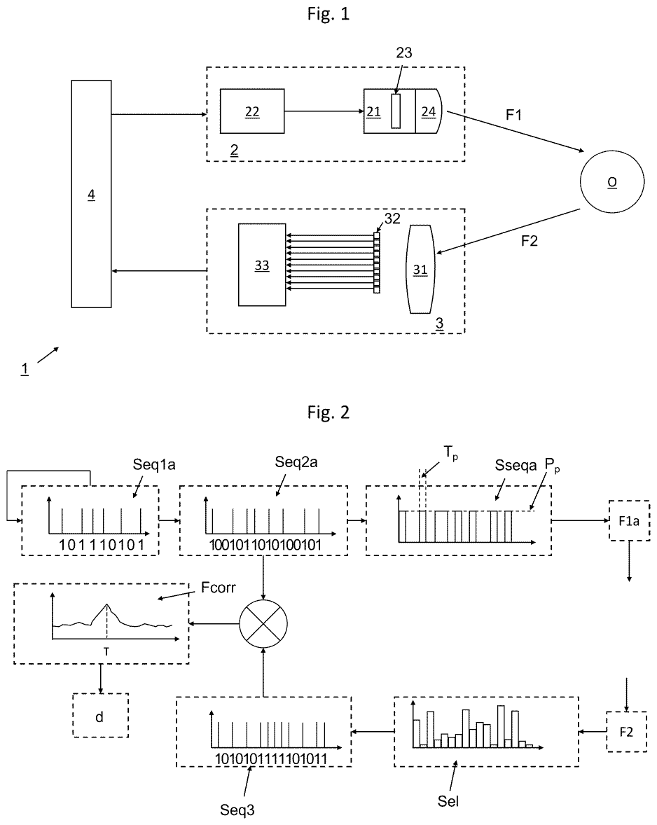

FIG. 1 shows a system 1 for an automotive vehicle according to one exemplary embodiment of the invention.

The system 1 comprises an emitting module 2 designed to emit a light beam F1 and a receiving module 3 intended to receive a light beam F2.

In the example described, the emitting module 2 and the receiving module 3 are arranged in the same front headlamp of the automotive vehicle. Provision may be made for the modules 2 and 3 to be arranged at different locations in the automotive vehicle, without departing from the scope of the present invention.

The emitting module 2 comprises a luminous module 21 intended to emit a light beam F1 and a modulation unit 22.

The luminous module 21 is arranged so that the light beam F1 that it emits has an electromagnetic spectrum of which at least one portion is located in the visible spectrum. In the example described, the spectrum has lines in a wavelength range between 400 nm and 500 nm. It will be noted that it is possible for the spectrum to have other intensity peaks, in the visible and/or in the infrared.

In order to emit this light beam F1, the luminous module 21 comprises a light source 23 capable of emitting light rays and an optical unit 24 arranged to project these light rays so as to form the light beam F1. In the invention, the optical unit 24 may equally comprise one or more reflectors, one or more lenses, one or more diaphragms, or one or more collimators, or a combination of several of these optical elements.

The light source 23 comprises, for example, a semiconductor generator (not shown), for example gallium nitride (GaN), capable of emitting, by electroluminescence and in response to an electric current passing through said generator, blue light rays with an emission peak at 450 nm. The light source also comprises a photoluminescent element, in the form of a resin comprising cerium-doped yttrium aluminum garnet (CE: YAG), capable of absorbing blue light and, by photoluminescence and in response to excitation by this light, of emitting yellow, orange or amber light rays.

The photoluminescent element is disposed on the generator in such a way that one portion of the blue light rays excites this element so that it emits, by photoluminescence, yellow, orange or amber light rays. The other portion of the blue light rays passes through this element. Thus, when supplied with electric power, the light source 23 simultaneously emits blue and yellow light rays, the light thus formed appearing orange or amber to the human eye.

Insofar as the light beam F1 is partially or wholly composed of orange or amber light, it is possible to use this light beam to partially or wholly participate in the performance of a predetermined, in particular regulatory, photometric function. In this case, the optical unit 24 is arranged to shape this light beam F1 so that the photometric distribution thereof satisfies the requirements of said function. In the example described, the light beam F1 participates in the performance of a direction-indicator function.

To this end, the modulation unit 22 cyclically controls the light source 23 so that, for a cycle, the light beam F1 is emitted for a period TTI, then deactivated for a period TTI. The function performed by the luminous module 21 is thus flashing and comprises a sequence of cycles each composed of an active phase, in which the light beam F1 is emitted, and an inactive phase, in which the light beam F1 is turned off.

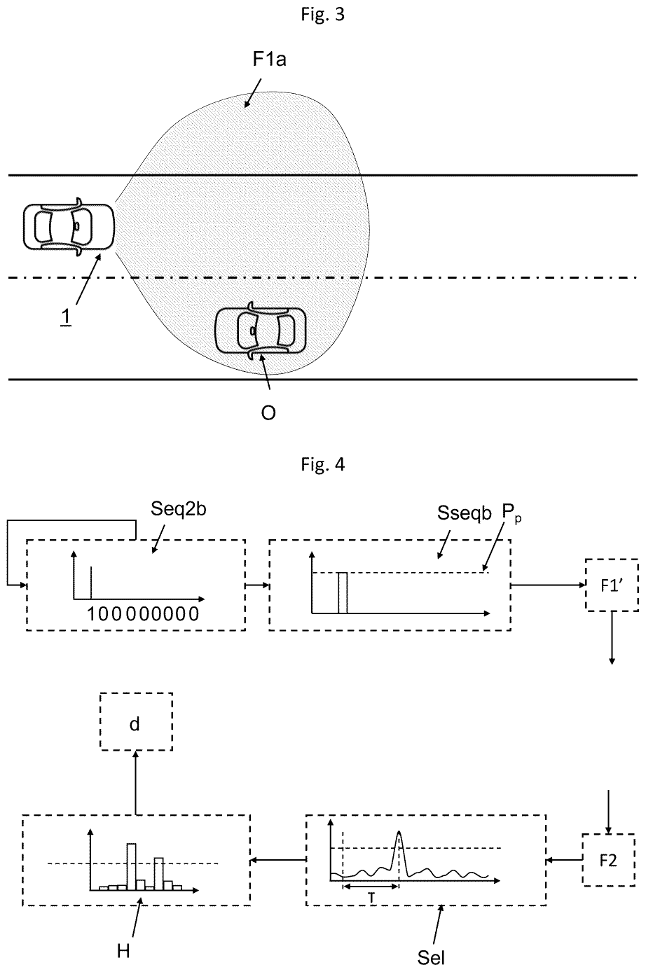

In addition to this photometric function, this light beam F1 allows the system 1 to perform functions of detecting and evaluating the position of an object on the road, as will be described in connection with FIG. 2, which shows a telemetry method carried out by the luminous system 1 using the luminous module 21, and with FIG. 3, which shows a view from above of a road scene when this telemetry method is carried out by the system 1.

The road scene in FIG. 2 shows an automotive vehicle equipped with the luminous system 1 according to the invention, and also a first object O1.

To carry out the telemetry method, the system 1 comprises a computing unit 4.

In a first step, initialized at the start of an active phase, the computing unit 4 periodically generates an initial data sequence Seq1a. The initial sequence Seq1a is, in the example described, a pseudo random binary sequence, composed of “0s” and “1s”, of maximum size, also called an M sequence, having a duty cycle of 50%.

In a second step, the computing unit 4 generates what is referred to as a first modulating data sequence Seq2a on the basis of the initial sequence Seq1a, preserving at least the same autocorrelation and cross correlation properties of the initial sequence Seq1a. For example, the computing unit may generate a first data sequence Seq2a whose duty cycle is less than 50%, while remaining greater than 10%. As a variant, there may be provision for the first modulating sequence Seq2a to be identical to the initial sequence Seq1a.

In a third step, the modulation unit 22 modulates the light beam F1 emitted by the luminous module 21 during each active phase, on the basis of this first data sequence Seq2a, for example by controlling the supply of electric power delivered to the light source 23.

In the example described, the modulation unit 22 comprises a generator of a pulse-frequency-modulated control signal. This control signal is used to control a switched-mode power supply (not shown) of the light source 23. Conventionally, the frequency setpoint of this control signal, set by the modulation unit 22, is thus used to control the average electric power delivered to the light source 23, and therefore to control the luminous intensity of the light beam F1, so as to meet the requirements of the photometric function it performs.

Thus, the modulation unit 22 converts the data sequence Seq2a into a modulating signal and modulates the initial control signal using this modulating signal. In other words, the light beam F1 thus emitted during an active phase under the control of the modulated signal Sseqa is composed of a train of light pulses. The pulses follow at a variable frequency high enough, for example greater than 10 MHz, in particular between 50 MHz and 100 MHz, that the human eye can no longer distinguish them. Moreover, the amplitude, the width and/or the position of each pulse with respect to the period allows the light beam F1 to convey the data sequence to the receiving module 3.

It will be noted that, in the example described, each light pulse corresponds to a bit with the value “1” in the modulating sequence Seq2a. The average power of a portion of the light beam F1 containing the first sequence Seq2a is thus defined by the number of bits with the value “1” in this sequence Seq2a in comparison with the total number of bits in this first sequence Seq2a, by the duration Tp of the pulses and by the peak power Pp of these pulses.

The average power P of the light beam F1 being constrained by the regulatory requirements surrounding the photometric function that the beam F1 has to perform, the computing unit 4 can thus determine the values of the peak power Pp and the pulse duration Tp according to the duty cycle of the first modulating sequence Seq2a and a photometric function setpoint, for example expressed as an average power setpoint or a frequency setpoint of the modulated signal Sseqa.

It will be noted that other types of modulation can equally be employed within the scope of the present invention, and in particular pulse code modulation (PCM), pulse amplitude modulation (PAM), pulse width modulation (PWM), or pulse position modulation (PPM).

The light beam F1 is thus emitted during each active phase until it reaches an object O, located in the environment of the vehicle, which reflects it in the direction of the receiving module 3. The light beam F2 received by the receiving module is thus composed of a portion of the light beam F1 reflected by the object O and of noise, for example generated by parasitic light sources such as urban lighting, automobile lighting, or even the sun.

As shown in FIG. 1, the receiving module 3 comprises an optical unit 31, downstream of which there is provided a plurality of elementary acquisition modules 32. The receiving module 3 further comprises a demodulation unit 33.

Each of the elementary acquisition modules 32 comprises a photodetector. The light beam F2 received by the receiving module 3 is thus focused by the optical unit 31 on one or more of the photodetectors.

The photodetectors are identical and are each formed by an avalanche photodiode of a silicon photomultiplier. These photodiodes are distributed in an array. It will be noted that the dimensions of the photodetectors are of the order of one micron. The assembly thus forms a sensor whose reception spatial resolution is of the order of 1°, or even 0.1°, and whose detection capabilities are particularly high, even in degraded acquisition conditions, due to the use of avalanche photodiodes.

In a fourth step, each of the photodetectors converts the portion of the light beam F2 it receives into an electrical signal Sel that it transmits to the demodulation unit 33, which can then extract what is referred to as a demodulated data sequence Seq3 therefrom in a fifth step.

In the example described, the demodulation unit 33 can, for example, count, from the electrical signal Sel, the number of photons received by an elementary acquisition module 32 during a time interval corresponding to a pulse duration Tp, then determine, by thresholding in comparison with a value determined on the basis of the peak power Pp, whether or not this quantity of photons corresponds to a pulse of the light beam F1, and therefore to a bit with the value “1” or to a bit with the value “0”.

The demodulated binary sequence Seq3 is thus transmitted to the computing unit 4, which estimates, in a sixth step, values of a correlation function Fcorr between the first modulating sequence Seq2a and the demodulated sequence Seq3.

The computing unit 4 thus evaluates, for a plurality of time shift values, the value of the cross correlation, by means of a cyclic convolution product, between the demodulated sequence Seq3 and the first modulating sequence Seq2a delayed according to each of the time shift values.

Given the autocorrelation and cross correlation properties of pseudo random binary sequences, the correlation function Fcorr will thus be maximum for a time shift value corresponding to the time of flight of the light beam F1, between the instant at which it is emitted by the emitting module 2 and the instant at which it is received by the receiving module 3, the first modulating sequence Seq2a delayed by this value thus corresponding substantially to the demodulated sequence Seq3, except for noise.

In a seventh step, the computing unit 4 identifies this maximum value of the correlation function Fcorr and estimates the value t of this time of flight of the light beam F1 between the object O and the vehicle that is associated with this maximum value.

In an eighth step E8, the computing unit 4 estimates the distance d between the object O and the vehicle.

Since the first light beam F1 performs a direction-indicator function, it is emitted only during the active phases of this function. Therefore, the system 1 is unable to carry out a telemetry function during the inactive phases of the flashing photometric function, which can impair the performance of advanced functions, such as tracking of an object O as it moves or as the vehicle moves, in particular if the relative speed of the object O and of the vehicle is high.

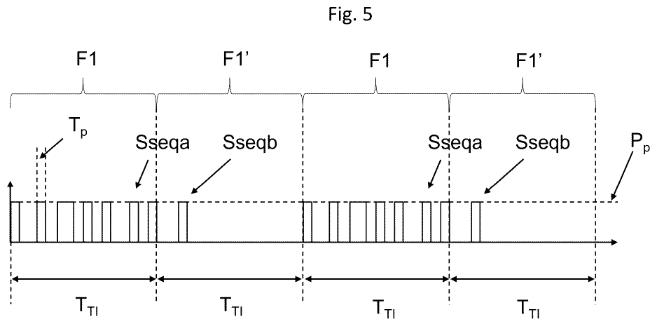

In order to ensure continuity of this telemetry function, when the first light beam F1 is deactivated during an inactive phase of the flashing photometric function, the luminous system 1 carries out another telemetry method using the luminous module 21, which then emits, during this inactive phase, a second modulated light beam F1′. FIG. 4 shows a telemetry method carried out by the luminous system 1 using the luminous module 21 during an inactive phase, and FIG. 5 shows a control signal Sseq obtained by means of the methods of FIG. 2 and FIG. 4 in the course of several cycles of the photometric function.

In a first step, initialized at the start of an inactive phase, the computing unit 4 generates a second modulating data sequence Seq2b having a duty cycle substantially lower than the duty cycle of the first modulating sequence Seq2a.

In the example described, the second modulating data sequence Seq2b may have a duty cycle less than or equal to 1%, for example by comprising a single bit with the value “1”, in such a way that the second modulated light beam comprises a single light pulse during a period corresponding to the total number of bits in the second modulating sequence Seq2b.

In a second step, a light beam F1′ is emitted by the luminous module 21 during the inactive phase, the modulation unit 22 modulating this light beam F1′ on the basis of this second data sequence Seq2b. The modulation unit 22 thus converts the second data sequence Seq2b into a modulating signal and modulates the initial control signal using this modulating signal.

In other words, the second light beam F1′ thus emitted under the control of the modulated signal Sseqb is composed of a single light pulse corresponding to the bit with the value “1” in the modulating sequence Seq2a. Since the peak power Pp of this pulse is identical to the peak power of the pulses of the first light beam F1, the low duty cycle of the second modulating sequence Seq2b allows the average power of the second light beam F1′ to be greatly reduced.

This low average power of the second light beam F1′ makes it substantially imperceptible, during the inactive phase, and keeps the second luminous module 21 substantially turned off, thereby allowing the regulatory requirements of the photometric function performed by the first light beam F1 to be met, this function remaining flashing with cycles of active and inactive phases.

On the other hand, the light pulse that this second light beam F1′ contains remains capable of reaching the object O so as to be reflected there towards the receiving module 3, so that the system 1 can continue the telemetry function during an inactive phase.

It will be noted that the second data sequence Seq2b is periodically transmitted during the inactive phase to the modulation unit 22 in such a way that the second light beam F1′ is composed, for a same inactive phase, of a train of light pulses that are separated by a constant time interval and whose duration is substantially greater than the duration of the light pulses.

In a third step, one or more of the photodetectors of the receiving module 3 converts the portion of the light beam F2 it receives into an electrical signal Sel that it transmits to the computing unit 4, which detects there, in a fourth step, for example by thresholding, the presence of a light pulse in this received light beam F2. The computing unit can directly estimate a time of flight t between emission of said light pulse of the second light beam F1′ and reception of said detected light pulse by the receiving module 3.

These third and fourth steps are thus repeated by the computing unit 4 until a series of light pulses is identified, corresponding to a train of light pulses emitted by the luminous module 21 in a same inactive phase. In a fifth step, the computing unit 4 generates a histogram H of the various times of flight thus determined.

In a sixth step, the computing unit 4 can thus detect the presence of one or more objects O in a field that is distant from the vehicle on the basis of the histogram H, for example by selecting one or more of the determined times of flight whose occurrences are higher than a given threshold, and can thus estimate a distance between said object(s) O and the vehicle on the basis of the selected times of flight.

As shown in FIG. 5, the luminous module therefore cyclically emits a light beam F1 during the active phases, under the control of the modulated signal Sseqa, and a light beam F1′ during the inactive phases, under the control of the modulated signal Sseqb, the sequences of the modulated signals Sseqa and Sseqb thus forming an overall modulated signal Sseq.

As a variant to the telemetry function just described in connection with FIG. 4, there may be provision for the second light beam F1′ to be modulated with a second data sequence Seq2b having more than one bit with the value “1”, as in FIG. 2, while ensuring that the duty cycle of this second data sequence Seq2b is particularly low in comparison with the first data sequence Seq1a. The computing unit 4 may then carry out the same steps of the method of FIG. 2 in order for the telemetry function to be performed by the luminous module 21 during the inactive phases.

The embodiment just described provides for the same module 21 to emit the first light beam F1 during the active phases and the second light beam F1′ during the inactive phases.

Provision may be made, in another embodiment that is not described, for the second light beam F1′ emitted during the inactive phases to be emitted by another luminous module, normally intended to perform another photometric function, for example a daytime running light, and possibly also to perform a telemetry function.

The above description clearly explains how the invention achieves its stated objectives, namely to provide a system for an automotive vehicle that is capable of simultaneously performing a flashing photometric function and a telemetry function on the basis of visible light and can detect an object, including during inactive phases of this flashing function. These objectives are achieved in particular by also performing a telemetry function during the inactive phases by modulating a second light beam emitted during these inactive phases with a duty cycle that is low enough for this second modulated light beam not to disturb the photometric function performed by the first light beam.

In any event, the invention is not limited to the embodiments specifically described in this document and particularly extends to all equivalent means and to any technically operative combination of these means. In particular, there may be provision for employing types of light source other than the one described, such as a laser diode, a VCSEL or an SLED. There may also be provision for performing photometric functions other than the one described, and in particular low-beam lighting functions or position-light signaling functions. There may also be provision for methods of generating a modulating sequence other than those described.

What is claimed is:

1. A luminous system for an automotive vehicle, comprising:
a. an emitting module including a luminous module capable of emitting a light beam whose spectrum has at least a portion in the visible spectrum, and a modulation unit designed to control the luminous module for the performance, on the basis of the emitted light beam, of a flashing photometric function including a sequence of successive cycles each composed of an active phase followed by an inactive phase, the modulation unit being capable of receiving what is referred to as a modulating data sequence, and being designed to modulate the emitted light beam on the basis of the sequence of received data;
b. a receiving module capable of receiving a light beam, wherein the receiving module includes an elementary acquisition module including a photodetector capable of converting a light signal it receives into an electrical signal; and
a computing unit designed to generate a first modulating data sequence having a first duty cycle and to transmit the first modulating data sequence to the modulation unit in order for a first modulated light beam to be emitted by the luminous module during each active phase; in that the computing unit is designed to generate a second modulating data sequence having a second duty cycle lower than the first duty cycle and to transmit the second modulating data sequence to the modulation unit in order for a second modulated light beam to be emitted by the luminous module during each inactive phase; and in that the computing unit is designed to determine a time of flight between emission of the first or second emitted modulated light beam and reception of a light beam received by the receiving module on the basis of an electrical signal converted by the photodetector on the basis of the received light beam.

2. The luminous system as claimed in claim 1, the luminous module includes a light source, the modulation unit being designed to control the light source in order for the first modulated light beam to be emitted by the luminous module during each active phase and to control the light source in order for the second modulated light beam to be emitted by the luminous module during each inactive phase.

3. The luminous system as claimed in claim 1, wherein the luminous module includes a first light source and a second light source, the modulation unit being designed to control the first light source in order for the first modulated light beam to be emitted by the luminous module during each active phase and to control the second light source in order for the second modulated light beam to be emitted by the luminous module during each inactive phase.

4. The luminous system as claimed in claim 1, wherein the computing unit is designed to generate a first data sequence having a first duty cycle higher than 10% and to generate a second data sequence having a second duty cycle lower than 5%.

5. The luminous system as claimed claim 4, wherein the computing unit is designed to generate a second data sequence having a duty cycle determined so that the second modulated light beam includes a single luminous pulse, and in that, the computing unit being capable of receiving an electrical signal converted by the photodetector on the basis of a light beam received by the receiving module, the computing unit is designed to detect a luminous pulse in the light beam received on the basis of the electrical signal and to determine a time of flight between emission of the luminous pulse of the second light beam and reception of the detected luminous pulse by the receiving module.

6. The luminous system as claimed in claim 1, further comprising a demodulation unit connected to the photodetector and designed to extract what is referred to as a demodulated data sequence from an electrical signal converted by the photodetector; and in that, the computing unit being capable of receiving a data sequence demodulated by the demodulation unit from an electrical signal converted by the photodetector on the basis of a light beam received by the receiving module, the computing unit is designed to estimate values of a correlation function between the demodulated data sequence and the first modulating data sequence and to determine a time of flight between emission of the first emitted modulated light beam and reception the received light beam on the basis of the values of the correlation function.

7. The luminous system as claimed in claim 1, wherein the computing unit is designed to generate and transmit the first modulating data sequence to the modulation unit in order for a first modulated light beam to be emitted by the luminous module during each active phase, in that the computing unit is designed to estimate a distance between the vehicle and an object in the environment of the vehicle on the basis of the determination of a time of flight between emission of the first modulated light beam and reception of a light beam received by the receiving module, in that the computing unit is designed to estimate a relative movement speed of the object with respect to the vehicle on the basis of the estimated distance, and in that the computing unit is designed to, when the estimated relative speed is greater than a given threshold speed, generate and transmit the second modulating data sequence to the modulation unit in order for a second modulated light beam to be emitted by the luminous module during each inactive phase.

8. The luminous system as claimed in claim 1, wherein the emitting module is arranged in a front headlamp of the automotive vehicle.

9. The luminous system as claimed in claim 8, wherein the luminous module is arranged so that the first light beam wholly or partially participates in the performance of a first predetermined regulatory photometric function.

10. The luminous system as claimed in claim 9, wherein the luminous module is arranged so that the first light beam wholly or partially participates in the performance of a first “direction-indicator” signaling function.
